(19) United States
(12) Patent Application Publication
(10) Pub. No.: US 2009/0044941 A1
(43) Pub. Date: Feb. 19, 2009

(54) Spherical Ceramic Proppant for Hydraulic Fracturing of Oil or Gas Wells, and a Process for Forming Cavities in the Surface of Spherical Ceramic Proppants

(76) Inventors: Gabriel Warwick Kerr De Paiva Cortes, Pocos de Caldas (BR); Guilherme De Paiva Cortes, Pocos de Caldas (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/993,313

(22) PCT Filed: Jun. 23, 2006
(86) PCT No.: PCT/BR2006/000121

§ 371 Date: Mar. 31, 2008

(30) Foreign Application Priority Data
Jun. 24, 2005 (BR) PI0502622-9

(51) Int. Cl. E21B 43/267; C09K 8/62

(52) U.S. Cl. 166/280.1; 507/271

(57) ABSTRACT

The present invention relates to improved spherical ceramic proppants for fracturing oil and/or gas wells, said proppants exhibiting spherical cavities on their surfaces. The novel proppants of the invention cause an increase in the turbulence of the oil and/or gas flow that passes through the facture where they are applied, with the consequent increase in the extraction productivity of oil or gas from these wells. The invention further relates to a process for forming cavities on the surface of spherical proppants.

### FIELD OF THE INVENTION

The present invention relates to an improved spherical ceramic proppant for the hydraulic fracturing of oil and/or gas wells.

### BACKGROUND OF THE INVENTION

Oil wells are formed by deposits of oils and/or gases, with the presence of water, brine or other liquids, in addition to organic material and other solid residues, enclosed in rocky or sandy formations. These wells may be of different levels of depth, from superficial to shallow, middle or deep wells. Upon drilling a well, the extraction of the oil or gas is initiated, said oil or gas coming out of the formation where it is, either through the natural permeability of the well or through natural cracks existing in the rock, until it reaches the surface, generally through metallic tubing.

Once the drilling phase has been completed and even before initiating the extraction per se, it is already possible to carry out hydraulic fracturing with the use of natural or synthetic proppants, with a view to obtain deeper wells. In any event, once the extraction has been initiated, as time passes goes by and through the continuous passage of oil or gas together with the dragging of solid residues through the pores and cracks, the passageways of the cracks are gradually closed, with reduction of the communication spaces existing in the well. The oil or gas flow decreases, with the consequent reduction of productivity, until it reaches such a critical condition that the extraction thereof is interrupted due to lack of economicity of operation Hydraulic fracturing techniques have been developed in order to renovate these unproductive wells or to improve the productivity of wells in operation, as well as to initiate drilling operations aiming at a higher well initial productivity. Those techniques consist in injecting fluids enriched with high-resistance solid agents into the existing boreholes, or into holes being bored, by causing the opening of new cracks in the rocks, which are filled with such solid agents, creating high-permeability passages and not allowing the cracks to close under the external pressures that occur at the time when the pressure used in the fracturing process is eliminated. Once the new cracks have been opened and filled, oil or gas begins to flow more easily through the cracks, which are filled with the solid agents.

The referred to solid agents, namely proppants, must have a strength sufficient to resist the confinement pressures exerted on the crack without breaking; they must resist the high temperatures encountered and the aggressive environment of the medium; they should have a geometrical form as spherical as possible and also very well adjusted granulometric dimensions in order to guarantee maximum permeability and conductivity of the medium within the crack.

Several solid materials have been used as proppants, such as sands, resined sands, steel shot, glass spheres, synthetic spherical ceramic, bauxite-based materials, clay materials and several other materials. Each of them has its advantages and disadvantages, and they have been used in numberless wells throughout the world.

Among the several documents known from the prior art and relating to spherical ceramic proppants, applicant can cite, for example, U.S. Pat. No. 4,440,866, which relates to a proppant produced from kaolinitic clays enriched with bauxite nodules, existing in Eufala, Ala., USA, containing about 46% SiO₂ and 51% Al₂O₃. This raw material, after being finely ground and after addition of sufficient water to produce barbotine, addition of dispersants and pH controlling agents, is atomized in equipment that generates pellets (pelletization).

Document U.S. Pat. No. 4,427,068 discloses proppants the pellets of which should contain at least 40% clay. U.S. Pat. No. 4,522,731 relates to a high-resistant proppant containing 40 to 60% Al₂O₃ and a density lower than 3.0 g/cm³, while U.S. Pat. No. 4,639,427 relates to a high-resistance proppant produced from bauxite with addition of zirconia.

Also document U.S. Pat. No. 4,623,630 relates to bauxite materials mixed with other materials, since it describes a proppant the pellets of which are produced essentially from a mixture of clays, bauxites and alumina. On the other hand, U.S. Pat. No. 4,658,899 is directed to proppants in which the pellets are produced essentially from a mixture of clays, bauxites and alumina, all of them being pre-calcined.

Another document that describes proppants made from bauxite mixed with clay is U.S. Pat. No. 4,668,645, which refers to a proppant manufactured from bauxite with clay, both being pre-calcined, and that has SO₂ contents between 16 and 19%, after calcination.

Further examples of documents that relate to bauxite mixtures are U.S. Pat. No. 4,879,181, referring to proppants with pellets composed of a mixture of calcined clay and calcined bauxite and containing at least 40% clay; U.S. Pat. No. 4,894,285, which relates to a proppant having clay as its main component, said clay being present in the pellets at a concentration of at least 40%, and U.S. Pat. No. 4,921,820, as well as its republication U.S. Re. 34371, which describe a proppant manufactured from a mixture of calcined kaolinitic clay and amorphous to microcrystalline silica, exhibiting a specific gravity lower than 2.70 g/cm³. Another document that describes the use of kaolinitic clay for this kind of product is U.S. Pat. No. 5,030,603, which relates to a proppant having specific gravity lower than 3.0 g/cm³, manufactured essentially from kaolinitic clay.

In document U.S. Pat. No. 4,921,821, one describes a proppant manufactured essentially from calcined kaolinitic clay, with less than 2% iron oxide and containing about 5% free silica in the form of quartz, exhibiting a specific gravity lower than 3.0 g/cm³.

U.S. Pat. No. 4,977,116 relates to a proppant manufactured from a mixture of kaolin calcined at low temperatures and amorphous to microcrystalline silica exhibiting a specific gravity lower than 2.70 g/cm³. U.S. Pat. No. 5,188,175 also relates to a proppant produced from kaolinitic clay or mixtures of kaolinitic clay with light aggregates, the proppant having alumina contents between 40% and 60% as Al₂O₃ and exhibiting a specific gravity lower than 3.0 g/cm³. Brazilian document PI 89003886-0 relates to a proppant manufactured from a mixture of kaolin calcined at low temperatures and amorphous to microcrystalline silica, exhibiting a specific gravity lower than 2.60 g/cm³.

Document EP 112,350 discloses a proppant wherein pre-calcined bauxite is used together with alkaline-earth metal flux in the form of talc, dolomite and calcic betonite in amounts higher than 3% each, for the purpose of reducing the sintering temperature.

On other hand, Brazilian document PI 9501449-7 relates to high-resistance proppant, manufactured from dry bauxite and the use of pelletization and sinterization additives of alkaline-earth compounds. The thus produced proppant exhibits maximum SiO₂ contents of 6.0%. Document PI 9501450-0 deals with a low-density proppant, manufactured exclusively from pre-calcined kaolinitic clays using pelletization and sinterization additives of alkaline-earth compounds.

Document PI 0301036-8 discloses a proppant for the hydraulic fracturing of oil or gas wells suitable for preventing the effect known as “flow-back” and that consists of a mixture of 10 to 95% by weight of a spherical proppant and 5 to 90% by weight of an angular material.

Brazilian patent application PI 0303442-9, in turn, describes spherical, ceramic, low-density proppant useful in hydraulic fracturing in shallow wells or intermediate-depth wells, with confinement pressures of up to 844 kg/cm2 (12,000 psi). The proppant according to that invention is obtained exclusively by sintering bauxites of the gibbsite type having a specific chemical composition, that is to say, bauxite with relatively high iron-oxide contents.

### SUMMARY OF THE INVENTION

The present invention relates to a spherical, ceramic proppant for use in the hydraulic fracturing of oil or gas wells, having cavities in its surface.

The present invention further relates to a process for preparing a spherical ceramic proppant containing cavities on its surface, and also to a process for forming said cavities on the proppant surface.

### DESCRIPTION OF THE DRAWINGS

FIGS. 1 to 3 show photographs of proppant pellets having cavities according to the present invention.

FIGS. 4 and 5 shows photographs of spherical proppants pellets of which have smooth surface.

FIGS. 6 and 7 show graphs containing data referring to the permeability of proppants according to the present invention in comparison with proppants comprising pellets of smooth surface.

### DETAILED DESCRIPTION OF THE INVENTION

The present inventors have found that spherical proppants having cavities in the surface bring about an increase in the turbulence of the oil and/or gas flow that passes through a fracture where they are applied, with a consequent increase in the productivity of oil or gas extraction from those wells, in comparison with the same type of fracturing agent having smooth surface like those known from the prior art.

The inventors have then developed a process for forming cavities in the surface of the proppant pellets by sintering the pellets obtained from natural ores containing crystallization water wherein the initial step of the process comprises just drying the starting material, without calcining same. It has been found that this process generates and/or increases the production of pellets with cavities and/or depressions, which may be spherical and/or irregular.

The term “cavities” as used herein, which may also be understood as “holes” or “depressions”, means cavities distributed over the surface of the spherical proppant pellets similar to a golf ball. In other words, they represent cavities or depressions on the surface of each particle of the ceramic proppant. Those cavities present on the surface of the proppants, reduce the resistance to flow of fluids when the latter pass through the empty spaces formed between the pellets inside the fracture obtained in the hydraulic fracturing process, which causes their permeability to increase.

The spherical proppants having cavities can be produced, for instance, from different bauxite and/or clay ores which just dried, finely ground, without any kind of coating or any component other than said ore, then simply pelletized with water without any pelletization additive, again dried and sintered at temperatures defined in accordance with the quality of the bauxite and/or clay ore employed in the process. In this way, they differ from the conventionally known spherical proppants, which require a calcinations step in its preparation for the purpose of removing the crystallization water contained in the primary raw materials.

It has been found, for example, that when bauxites are just dried at a temperature ranging from 95 to 105° C., they can still contain up to 30% by mass of crystallization water. This crystallization water will only be gradually eliminated when the pellets are sintered, by raising the temperature in the sintering oven after temperatures higher than 300° C. are reached. The last traces of the presence of this crystallization water will only be eliminated at temperatures ranging from 1000° C. to 1200° C. During this stage, at temperatures ranging from 95° C. to 1000° C., the spherical pellets are free from crystallization water and their initial volume is slightly changed, that is to say, they undergo a very small volume retraction and will consequently have a high-porosity characteristic.

As from 1000° C. the process temperature increases until the proppant sinterization takes place. The sintering temperature will depend on the chemical composition of the raw material used, on its sinterability degree and on its fineness after grinding. It will also depend on the time the pellets remain in the oven.

During the sintering step, there is a decrease of the volume of the pellets wherein said pellets undergo, a process of very large volumetric retraction which may reach levels of 50%. The retraction will preferably occur in the direction of the pores left in the pellets after elimination of crystallization water with the consequent formation of cavities on the surface of the pellets.

The inventors have unexpectedly found that proppants obtained from just dried natural raw materials, with practically all the volume of crystallization water existing in the original raw material, will present cavities and/or surface depressions, either spherical or irregular. This phenomenon does not occur when raw materials that are pre-calcined and/or calcined are used before being ground and pelletized (“calcination” is to be understood as the step intended for eliminating crystallization water). Since they no longer contain crystallization water to be removed, the number of pores left in pellets prepared by the usual and conventional calcination step preceding the sintering process will be infinitely smaller and, as a result, there will also be little volumetric retraction of the pellets in the sintering process. Consequently, proppants obtained from pre-calcined and/or calcined raw materials in which the crystallization water is eliminated from the original raw materials prior to the grinding and pelletizing processes exhibit smooth surfaces.

For the sake of more clearness, the term “sintering” is defined herein as a heat treatment, defined by a calcination step at high temperatures ranging from 1200° C. to 1700° c. The sintering temperature is that at which the material completes its chemical reactions and definitively changes its mineralogy remaining thermoplastic and close to ifs melting or softening point. The sintering temperature will depend on the raw material chemical composition, its fineness after being ground, the compaction degree occurred in the pelletizing phase and its degree of sinterability (higher or lower susceptibility of the material to sintering). It will also depend on the time the pellets remain in the oven at that temperature.

According to a preferred embodiment of the present invention, the raw material preferably used for the proposed proppant, although not limitative, is bauxite which occurs in large amount at the Poços de Caldas Plateau, in the state of Minas Gerais, Brazil. Bauxite is a mixture of hydrated aluminum oxides of indefinite composition containing accessory iron, silicon, titanium, sodium and potassium minerals. The main constituents of bauxite may be: gibbsite ([Al(OH)₃], bohemite ([AlO(OH)] and diaspore [HAlO₂]. At the Poços de Calda Plateau gibbsite predominates, which is a tri-hydrate with about 33% of crystallization water.

With respect to the ores from the Poços de Calda Plateau, contamination of bauxite takes place predominantly by clay minerals, particularly from the group of kaolinite, iron oxide, predominantly goethite and hematite and titanium oxides, predominantly ilmenite. The presence of calcium and magnesium oxides, potassium oxide, phosphorus pentoxide and zinc oxide may occur in very small amounts. The amounts of iron oxide are relatively large, always higher than 6%, and the amounts of titanium oxide are relatively low, generally lower than 2%. The presence of free quartz is virtually negligible.

Since the amount of clay mineral in that material (which introduces the silicon dioxide in the system) may virtually vary from 1% to about 30%, the amount of the ore is generally evaluated by the relation SiO₂/Al₂O₃ ratio. Ores with very high clay mineral contents may be beneficiated by washing with water. The clay material remains suspended in the water that is separated from the system through sieves or by centrifugation, leaving the ore with very low contents of silicon dioxide and high contents of Al₂O₃. For this reason, the following limits are generally used for classifying the existing types of bauxite:

1—low-quality bauxite ore (high SiO₂ contents and low Al₂O₃) contents:

SiO₂=28%

Al₂O₃=58%

SiO₂/Al₂O₃ Ratio=0.482

2—high-quality bauxite ore (low SiO₂ contents and high Al₂O₃ contents:

SiO₂=1%

Al₂O₃=85%

SiO₂/Al₂O₃ Ratio=0.11

High-quality bauxite has an amount of crystallization water higher than 30%, while low-quality bauxite has less than 20%. In intermediate qualities the crystallization water ranges from 20 to 30%. It has been found that for any of the qualities employed, there will always be sufficient crystallization water to contribute for the formation of the cavities, holes or depressions of the proppants. Pre-calcined and/or calcined ores no longer contain crystallization water, which is removed in the pre-calcining and/or calcining process prior to grinding and pelletizing.

The quality of the bauxite preferably used in the present invention proppants manufacturing exhibits the variation indicated in Table 1. Any of them has an amount of crystallization water (indicated by the loss by calcination “P.F.”) suitable to form cavities, holes or depressions in the pellet surfaces.

TABLE 1

| Oxide | Contents (%) |
|---|---|
| Al₂O₃ | 50.0 to 85 |
| Fe₂O₃ | 8.0 to 15.0 |
| SiO₂ | 5.0 to 15.0 |
| TiO₂ | 1.0 to 2.0 |
| P.F. | 23.0 to 30.0 |

Depending on the year season, the bauxites may contain moisture water at contents ranging from 5 to 25%, which will be eliminated by a drying process.

According to a preferred process for obtaining the proppant of the invention, adequate bauxite selected on the basis of the characteristics mentioned before, either washed or not, is deposited in an appropriate place in open air and is then dried in any conventional drying equipment and finely ground. The grinding equipment is not restrictive of the process and may be any equipment conventionally used for this purpose. The thus obtained dried and ground bauxite is then mixed with water, without additives, in pelletizers that will form green pellets of widely varying granulometry.

The pellets leaving the pelletizers are dried for total or partial elimination of moisture water, being then classified through sieves, segregating the fractions that are coarser and finer than the desired granulometric range. The intermediate fraction is the more suitable for the process. The segregated coarser and finer fractions return to the productive cycle, being introduced during the grinding process.

The intermediate fraction of the classified and dried pellets is then sintered in rotary ovens, of fluidized-bed ovens, or intermittent ovens, or any others according to the above given sintering definition and cooled in rotary coolers or any other conventional coolers used for this purpose.

In this step, the dried pellets are led in the opposite direction of the heat, that is to say, the entry of the pellets takes place at the oven part that has a lower temperature, while their exit is placed at the part having a higher temperature. These are ovens that operate in countercurrent. Gradually, as the pellets are heated, the gibbsite [Al(OH)₃] breaks up into different mineralogical forms of aluminum oxide, while the pellets release water vapor to the atmosphere. This process occurs until a determined point at which the pellets temperature does not exceed 800° C.; the mineralogical form of alumina is predominantly α-Al₂O₃ with variable proportions of other instable alumina forms. These are highly instable, high-porosity and high-reactivity forms of alumina.

Other hydrated compounds existing in the original raw material, such as clay minerals and iron oxides, break up in the process as well. The clay minerals break up predominantly into crystobalite (SiO₂) and probably alumina forms as mentioned for gibbsite, releasing water to the atmosphere. The hydrated iron oxides break up into hematite α-Fe₂O₃, also releasing water to the atmosphere. From that point on, as the temperature of the pellets increases, the sintering process is initiated. The alumina in instable form changes into coridon (α-Al₂O₃) of tabular crystals, the only stable form of alumina, of high hardness (hardness 9 according to the Mohs scale) and of high strength. Crystobalite reacts with part of the alumina to form mullite (Al₆Si₂O₁₃), a stable aluminum silicate. The iron oxides in the form α-Fe₂O₃ (hematite), remain partly free as hematite crystals and partly coming into solid solution with the formed mullite and coridon. Also, virtually all titania, TiO₂, present in the bauxite remains in solid solution with corindon and with mullite. Hematite together with the hematite and titania in solid solution with corindon and mullite deposit around the corindon and mullite crystals, forming particles ceramically cemented and of high quality.

In the sintering step described above, apart from the chemical reactions that take place, a volumetric retraction of the particles also occurs, generally on the order of 50% by volume, in the direction of the initial inner pores of the still reactive pellets. During such retraction process, pores are formed, distributed over the whole surface of the pellets. The thus obtained pellets are granulometrically classified through sieves in order to meet the specification of the required pellet size.

Proppants presenting pellets with cavities on their surface according to the present invention were analyzed for their permeability and conductivity characteristics.

Conductivity and permeability are the key words as far as the use of a proppant for hydraulic fracturing of gas or oil wells are concerned. The whole process of hydraulic fracturing of gas or oil wells has the objective of obtaining an increase in the productivity of said gas or oil well, by increasing the permeability of the fractured medium with the use of the proppant.

A number of assays are used to characterize a proppant, most of which being defined and recommended in the “Recommended Practices for testing High strength Proppants used in Hydraulic Fracturing Operations, API Recommended Practice 60 (RP-60), American Petroleum Institute, Washington, D.C., USA”. The most important of them is not normalized yet, an adaptation of the RP 61 being used today with procedures well defined by international laboratories such as StimLab Laboratories, in Duncan, Okla., USA, and Fractech Ltd. in London, United Kingdom.

The assay for permeability of the proppant is one of the most important, since the greater the permeability of the medium created by the proppant the higher the productivity of the well. In fact, what is actually desired with the hydraulic fracturing technique with proppants is to create a medium having greater permeability.

The measurement of the conductivity and of the permeability is carried out by putting determined amounts of proppant in a cell under a determined confinement pressure and for a determined time. A liquid is caused to pass through the proppant at defined and constant flow rates, temperatures and pressures. The confinement pressure and the number of layers are increased slowly and simultaneously to defined pressures, as for example, 576.4 Kg/cm² and 14.1 Kg/cm² (8200 psi and 200 psi), respectively, which means an initial closing pressure of 564 Kg/cm2 (8000 psi). The fracture conductivity is then measured. While measuring the conductivity, the closing pressure and the temperature are kept constant, whereas the current of fluid and the differential pressure are recorded. During the whole assay, the proppant layer is subject to a constant fracturing pressure, for example, 564 Kg/cm² psi), at a constant temperature of 148.8° C. (300° F.). The fracture conductivity is measured at intervals of 25 hours. The confinement pressure is raised from 141 Kg/cm² (200 psi) every 50 hours, until a pressure of 1055 Kg/cm² (15000 psi) is reached.

Table 2 presents examples of results achieved in evaluating the permeability and the conductivity of a 20/40 proppant according to the present invention in layers of 9.7 Kg/cm² (2.0 lb/ft).

TABLE 2

| CONFINEMENT | PERME- | | |
|---|---|---|---|
| PRESSURE | ABILITY | | CONDUCTIVITY |
| Kg/cm² (PSI) | (md) | WIDTH cm (in) | md · m (md-ft) |
| 88 (1250) | 284349 | 0.426 (0.16761) | 1210 (3072) |
| 176 (2500) | 252567 | 0.413 (0.16249) | 1042 (3420) |
| 264 (3750) | 222413 | 0.402 (0.15816) | 893 (2931) |
| 352 (5000) | 216069 | 0.395 (0.15540) | 852 (2798) |
| 439 (6250) | 209683 | 0.389 (0.15304) | 815 (2674) |
| 527 (7500) | 208619 | 0.383 (0.15068) | 791 (2594) |
| 615 (8750) | 199225 | 0.377 (0.14832) | 750 (2462) |
| 703 (10000) | 191507 | 0.370 (0.14556) | 508 (2325) |
| 791 (11250) | 189489 | 0.367 (0.14438) | 695 (2280) |
| 878 (12500) | 179364 | 0.361 (0.14202) | 647 (2122) |

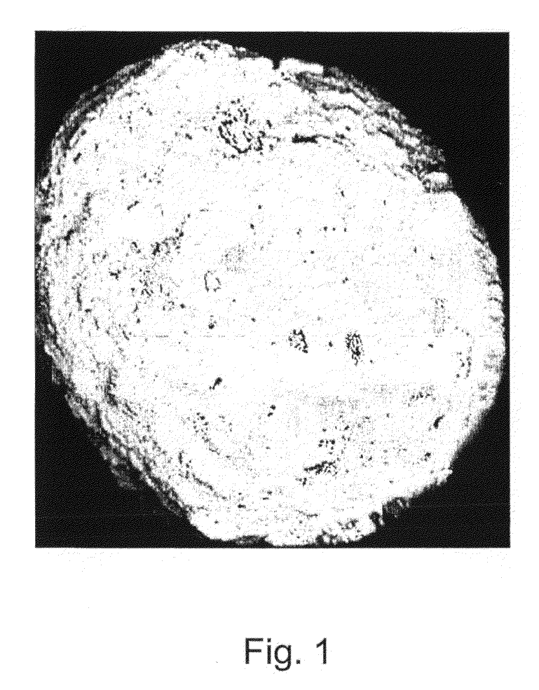

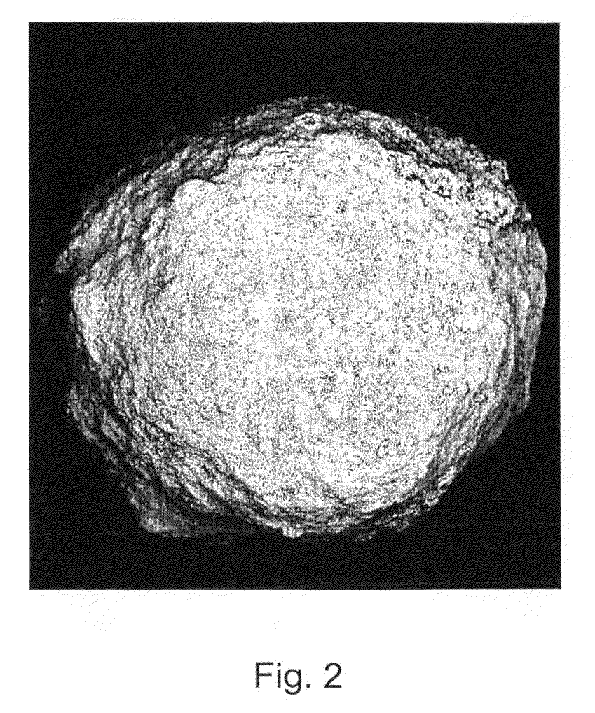

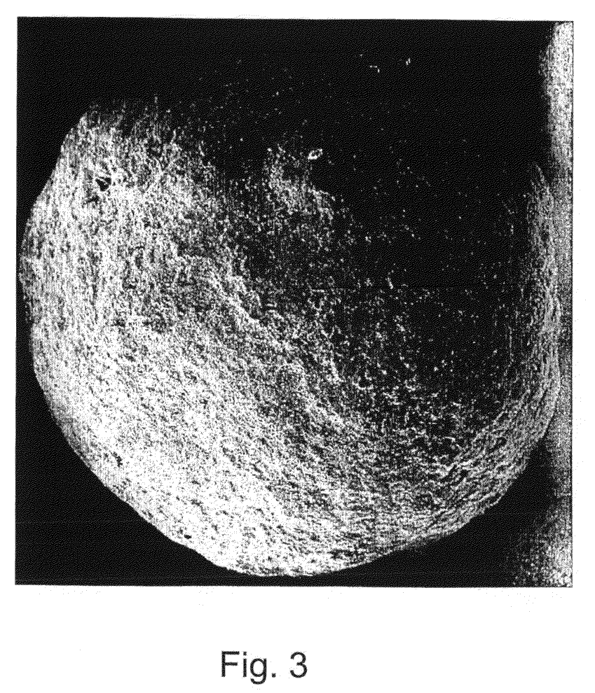

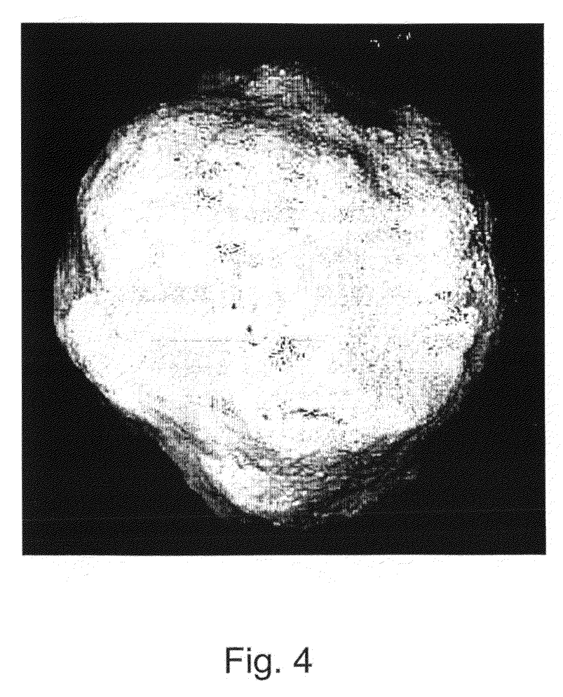

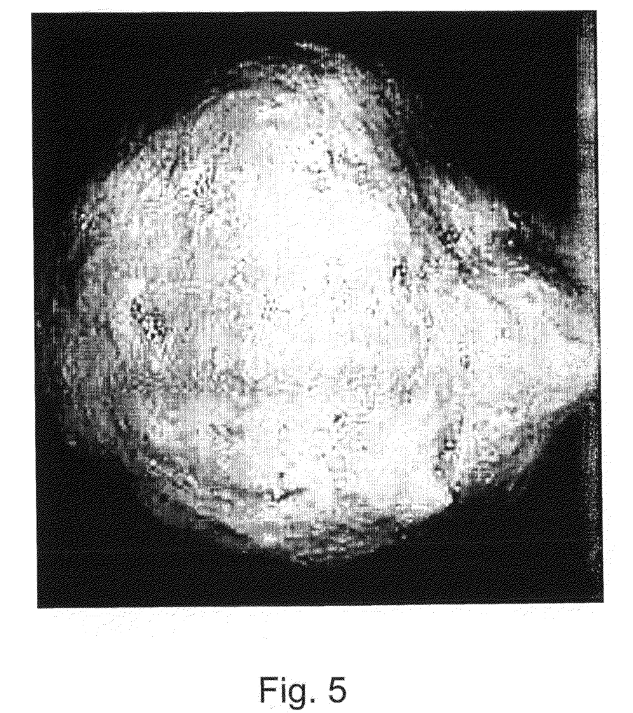

FIGS. 1 to 3 are photographs of spherical proppants according to the present invention, called A-type proppants, with pellets having cavities on their surface. On the other hand, FIGS. 4 and 5 are photographs of prior art spherical proppants, called B-type and C-type proppants, respectively, having pellets with a smooth surface, obtained by sintering pre-calcined and/or calcined raw materials and, consequently, without crystallization water sufficient to form the cavities, holes and depressions.

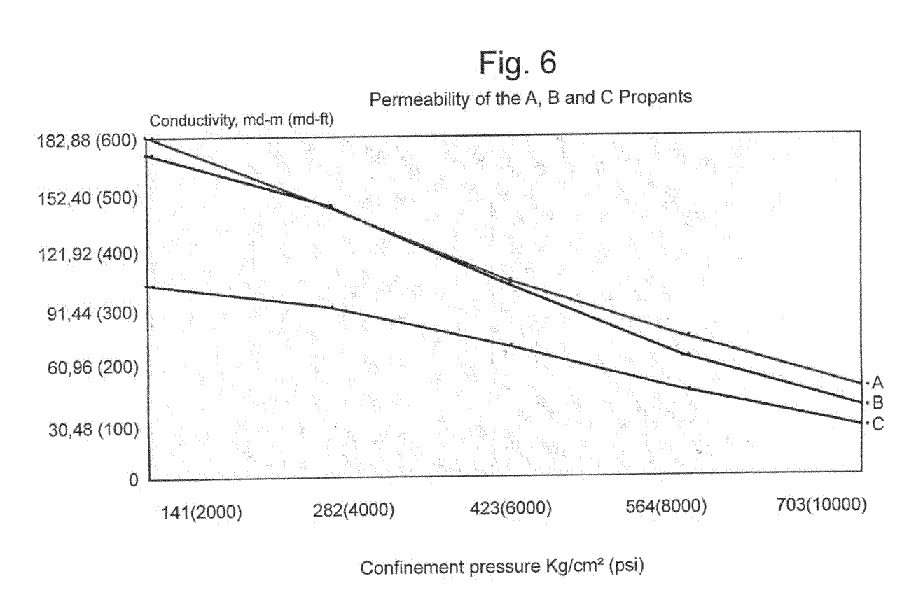

FIG. 6 shows permeability data of the A proppant in comparison with two other commercial proppants of smooth surface, called B proppant and C proppant. The data were obtained by using Ohio Standstone Core for 50 hours and at 2 Lbs/ft² (9.768 Kg/m²), 120° C. (250° F.) and 2% KCl.

An analysis of FIG. 6 and Table 3 below shows that proppants having surfaces with depressions and/or holes exhibit higher permeability than proppants with smooth surfaces. Consequently, this being the only variable, the productivities of gas or oil wells will be higher by using A proppant, which has depressions and/or holes, than when B-type and C-type proppants having smooth surface are employed.

TABLE 3
Permeability × Confinement Pressure Kg/cm2 (psi)

| | 141 | 282 | 423 | 564 | 703 |
|---|---|---|---|---|---|
| | (2000) | (4000) | (6000) | (8000) | (10000) |
| A | 601 | 478 | 347 | 245 | 154 |
| B | 570 | 480 | 340 | 210 | 120 |
| C | 340 | 300 | 230 | 150 | 85 |

Another factor of utmost importance in predicting and/or evaluating the quality of a proppant that will provide higher productivity of the well is that which is observed by determining the beta factor. For a better understanding, the following considerations are provided on the laws that govern the influences determined through darcyan flows and non-darcyan flow, by Darcy's law and Forchheimer's law.

The main differences between the equations relating to Darcy's law and Forchheimer's law are:

Henry Darcy Correlation: Darcy's law considers only the friction and the viscous effects as responsible for the decrease in confinement pressure.

The Forchheimer's Equation adds to the Darcy's considerations the action of the inertial fluid in decreasing the confinement pressure.

The mathematical expression of Darcy's Equation is:

Δp/L=μv/k, wherein

Δp/L=loss of pressure in the length of the proppant layer—it is directly proportional to the fluid velocity

μ=velocity of the fluid flow

v=surface velocity of the fluid flow (assuming a porosity of 100%)

k=porous medium permeability

The mathematical expression of Forchheimer's Equation is:

Δp/L=μv/k+βρv². wherein

Δp/L=loss of pressure of the length of the proppant layer—it is directly proportional to the square of the velocity of the fluid

Δp/L=μv/k is Darcy's Equation, shown previously,

β=beta factor (inertial factor)

ρ=fluid density

v=surface velocity of the fluid.

The Permeability Rule RP-61 is based on Darcy's law and for applying Darcy's law the surface velocities should be low and, consequently, in this rule the surface velocities used are on the order of 0.2 to 2.0 inches/min (0.5 to 5 cm/min). In real cases of hydraulic fracturing, the surface velocities may exceed 3658 cm/min (2 inches/sec), which means velocities 1000 times as high as those applied on a laboratory scale and based on Darcy's law.

This means:

Rule RP61=0.5 to 5 cm/min

Real cases=3658 cm/min

Consequently, high flow ratios will result in greater initial flow resistance. The pressure gradient required for a high flow is higher than Darcy's Equation can predict. The deviation from Darcy's Equation increases with the flow rate and is proportional to the density of the fluid and to the square of the surface velocity of the fluid.

The permeability values obtained in accordance with RP61 are only indicative, since in real cases the permeabilities will be much higher than those obtained.

In an attempt to minimize this problem, Forchheimer adds a factor to Darcy's equation, called beta factor. The loss of pressure in the fracture is related to the modifications of the real fluid-velocity rates. Those modifications are directly related to the characteristics of the proppants. Forchheimer's Equation adds the beta factor. for a realistic fracturing flow rate. Hence the importance of determining the beta factor as an indicative data for the selection of the most adequate proppant for achieving maximum productivities.

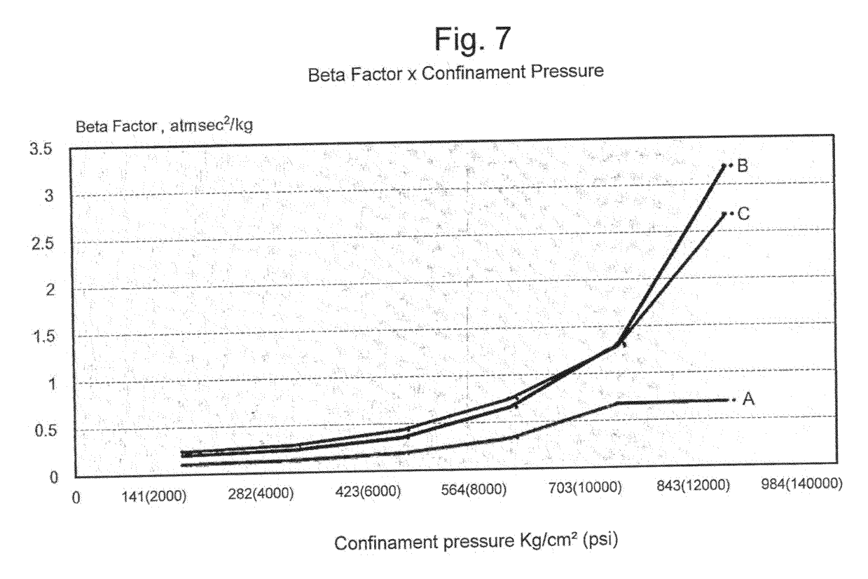

FIG. 7 presents a graph that clearly shows the superiority of the proppants having surface holes and/or depressions represented by A proppant A. The data have been obtained with proppants having granulometry of 20/40 at 300° F. (149° C.) and 2 Lbs/ft² (9.768 Kg/m2).

It can be seen that the Proppant A exhibits a lower beta factor than the others. Reminding that the smaller the beta factor the higher the productivities of the oil or gas wells, it is concluded that oil or gas wells fractured with Proppant A will have a better performance than those fractured with prior art proppants B and C that have smooth surfaces.

TABLE 4
Beta Factor × Confinement Pressure Kg/cm² (psi)

| | 141 | 282 | 423 | 564 | 703 | 743 |
|---|---|---|---|---|---|---|
| | (2000) | (4000) | (6000) | (8000) | (10000) | (12000) |
| A | 0.105 | 0.129 | 0.184 | 0.327 | 0.678 | 0.690 |
| B | 0.20 | 0.24 | 0.35 | 0.66 | 1.31 | 3.19 |
| C | 0.24 | 0.29 | 0.43 | 0.75 | 1.29 | 2.68 |

1. Spherical ceramic proppant for use in hydraulic fracturing of oil or gas wells, characterized by exhibiting cavities on its surface.

2. Proppant according to claim 1, characterized in that it is from bauxite, clay or mixtures thereof.

3. Proppant according to claim 2, characterized in that it is prepared from bauxite material comprising from 50.0 to 85%, by weight, of AI₂O₃ in a calcined bauxite base, from 8.0 to 15%, by weight, of Fe₂O₃ in a calcined bauxite base, from 5 to 15%, by weight, of SiO₂ in a calcined bauxite base and form 1.0 to 2.0%, by weight, of TiO₂ in a calcined bauxite base.

4. A process for forming cavities on the surface of a spherical ceramic proppant, characterized by comprising the steps of drying, grinding and pelletizing the raw material, followed by a step of sintering the pelletized material, said method not comprising calcination steps prior to said pelletizing step.

5. A process according to claim 4, characterized in that the raw material is selected from bauxite, clay or mixtures thereof.

6. A process according to claim 4, characterized in that the drying step is carried out at a maximum temperature ranging from 95 to 115° c.

7. A process according to claim 4, characterized in that the sintering step is carried out at a temperature ranging from 1000 to 1200° C.

8. A process according to claim 4, characterized in that the raw material is a bauxite material comprising from 50.0 to 85%, by weight, of AI₂O₃ in a calcined bauxite base, from 8.0 to 15%, by weight, of Fe₂O₃ in a calcined bauxite base, from 5 to 15%, by weight, of SiO₂ in a calcined bauxite base and form 1.0 to 2.0%, by weight, of TiO₂ in a calcined bauxite base.

9. A process for the hydraulic fracturing of oil or gas wells, characterized by using, as hydraulic-fracturing proppant, a proppant as defined in claim 1.
